(19) United States
(12) Patent Application Publication
(10) Pub. No.: US 2019/0029232 A1
(43) Pub. Date: Jan. 31, 2019

(54) System for Breeding Zebrafish

(71) Applicants: Centre National de la Recherche Scientifique (CNRS), Paris (FR); Institut National de la Recherche Agronomique, Paris (FR)

(72) Inventors: Emmanuel Dijoux, La Possession, La Réunion (FR); Laurent Legendre, Villebon-Sur-Yvette (FR); Frédéric Sohm, Gif-Sur-Yvette (FR)

(21) Appl. No.: 16/074,486

(22) PCT Filed: Jan. 31, 2017
(86) PCT No.: PCT/EP2017/051999

§ 371 Date: Aug. 1, 2018

(30) Foreign Application Priority Data
Feb. 1, 2016 (FR) 1650790

(51) Int. Cl. A01K 61/17; A01K 63/00

(52) U.S. Cl. CPC A01K 61/17; A01K 63/047; A01K 63/003

(57) ABSTRACT

Breeding system (1) for fish belonging to the Cyprinidae family, and more particularly for zebra fish of the species Danio rerio, the said system comprising a breeding tank (2) having a bottom (2a) and side walls (2b), a spawning support (3) placed in the breeding tank (2) and comprising a platform (4) forming a spawning zone positioned a distance away from the bottom (2a) of the breeding tank (2), and a water circulating system (17) configured to modify the water level in the breeding tank (2) and at least partially flood the platform (4) of the spawning support (3), in which breeding system the spawning support (3) comprises a funnel (7) comprising a truncated conical wall (8) having a lower orifice (9) extending near the bottom (2a) of the breeding tank (2) and in fluidic communication with the water circulating system (17) by means of a pipe (11), and an upper orifice (10) extending some distance away from the bottom (2a), the platform (4) being fixed near the upper orifice (10) of the funnel (7), and the breeding system further comprises a removable shut-off member (13) configured to at least partially block off the pipe (11) of the spawning support (3) so as to increase the water level in the breeding tank (2) so as to at least partially flood the platform (4), the shut-off member (13) comprising a pipe at the end of which through-holes are formed, the said pipe having a height that is greater than a distance between the lower orifice (9) and the upper orifice (10).

### FIELD OF THE INVENTION

The invention relates to a mass breeding system adapted for the species of fish belonging to the Cyprinidae family, and more particularly zebra fish of the species Danio rerio.

### TECHNOLOGICAL BACKGROUND

Achieving spawning of fish of the Cyprinidae family, and more particularly zebra fish of the species Danio rerio, at high egg yield needs a large workforce and frequent handling of breeding fish.

In fact, the animals have to be constantly kept at a temperature of 28° C. to ensure regular and substantial egg production (300 to 500 eggs per female each week over six months). Moreover, the animals have to spawn regularly and a step prior to selection of couples is necessary for selecting the most effective animals.

Furthermore, a transitory training period is important for the young females at the start of cycle (up to 3 unsuccessful sessions).

Usually, to control spawning and increase the numbers of eggs obtained from spawning, the males and females are kept separate in dedicated tanks and are combined only the day before the day planned for the spawning in aquariums prepared specifically for this purpose. Then, once spawning is complete, the fish are caught, separated by sex and replaced in their initial tank, which is long and fastidious for operators to do.

In this way, the single breeding event of thirty couples of breeding fish of the Cyprinidae family represents a daily load of around 1 h 30.

The surface available in animal research facilities is generally highly restricted. But in the case of breeding fish belonging to the Cyprinidae family, many tanks are needed to respect the breeding mode of these fish.

It has also been proposed to leave the fish in the same tank to reduce handling by operators. But this system fails to produce spawning peaks of animals at any given time, with the animals spawning continuously during the daytime and consequently losing efficiency. Such a technique is therefore not optimal in animal research facilities which needs to be able to obtain a large number of eggs in a short period and at any given time to conduct experiments (such as injections at ‘1 cell’ stage requiring premature eggs to be obtained). Moreover, the eggs obtained are generally mixed in with fish faeces and therefore must be separated prior to use.

### SUMMARY OF THE INVENTION

An aim of the invention therefore is to propose a breeding system for reducing the handling time necessary for operators to ensure substantial production of eggs from fish belonging to the Cyprinidae family in a short period and at any given time, and more particularly zebra fish of the species Danio rerio, without as such impairing the regularity of spawnings or reducing the number of eggs which can be obtained. Secondarily, the solution proposed must be able to be executed in animal research facilities which have limited space.

For this, the invention proposes a breeding system (1) for fish belonging to the Cyprinidae family, and more particularly for zebra fish of the species Danio rerio, said system comprising:
a breeding tank having a bottom and side walls,
a spawning support placed in the breeding tank and comprising a platform forming a spawning area placed at a distance from the bottom of the breeding tank, and
a water circulation system configured to modify a water level in the breeding tank and flood at least partially the platform of the spawning support.

Some preferred but non-limiting characteristics of the breeding system described hereinabove are the following, taken individually or in combination:
furthermore the breeding system comprises a collecting tank in communication with the platform, said collecting tank being configured to harvest eggs laid by fish on the platform,
the collecting tank comprises a strainer configured to harvest eggs laid by fish on the platform,
the breeding system comprises several breeding tanks in communication with a single collecting tank, said single collecting tank being in communication with the platform of each breeding tank and configured to harvest eggs laid by fish on said platforms,
the breeding system comprises a compartmented breeding tank, each compartment comprising a platform in communication with the collecting tank, said collecting tank being configured to harvest eggs laid by fish on each of the platforms,
the water circulation system comprises piping and a pump and is configured to circulate water between the breeding tank and the collecting tank so as to modify a water level in the breeding tank,
the spawning support comprises a funnel comprising a truncated conical wall having a lower orifice, extending near the bottom of the breeding tank and in fluidic communication with the water circulation system by means of a pipe, and an upper orifice extending at a distance from the bottom, the platform being fixed near the upper orifice of the funnel,
the platform comprises a screen configured to prevent fish from entering the conical part of the spawning support while letting eggs enter the funnel,
the conical wall of the funnel has through perforations, formed at a predetermined distance from the platform forming a spawning area, for example at a distance between 1 cm and 5 cm,
the breeding system also comprises a removable shutoff member configured to at least partially block the pipe of the spawning support to increase a water level in the breeding tank to at least partially flood the platform,
the shutoff member comprises a pipe at the end of which through-holes are formed, said pipe having a height greater than a distance between the lower orifice and the upper orifice,
the platform is tiltable, and/or
a ratio between the surface of the platform and a surface of the bottom of the breeding tank is between 0.3 and 0.5.

### BRIEF DESCRIPTION OF THE DRAWINGS

Other characteristics, aims and advantages of the present invention will emerge more clearly from the following detailed description and with respect to the appended drawings given by way of non-limiting examples and in which:

FIG. 1 is a perspective view of an embodiment of a breeding system according to the invention, during a step for breeding fish.

FIG. 2 is a side view of the spawning support of the example of FIG. 1, the platform being flooded for breeding fish.

FIG. 3 is a side view of the spawning support of the example of FIG. 1, the platform being flooded and tilted for breeding fish.

FIG. 4 is a side view of an embodiment of a shutoff member which can be used in a breeding system according to the invention.

FIG. 5 is a side view of an embodiment of a collecting tank which can be used in a breeding system according to the invention.

FIG. 6a is a sectional view of an embodiment of a spawning support comprising a funnel according to the invention, prior to flooding of the platform.

FIG. 6b is a sectional view of the spawning support of FIG. 6a blocked at least partially by an embodiment of a removable shutoff member for flooding the platform.

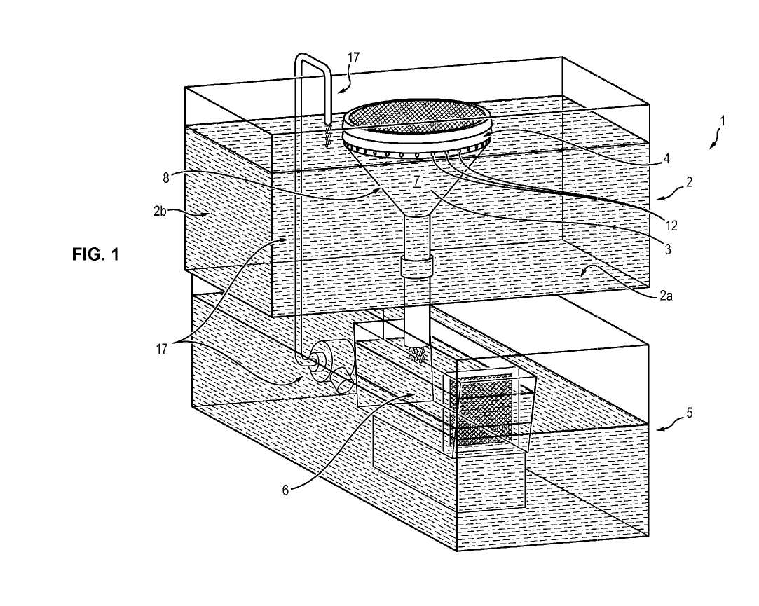

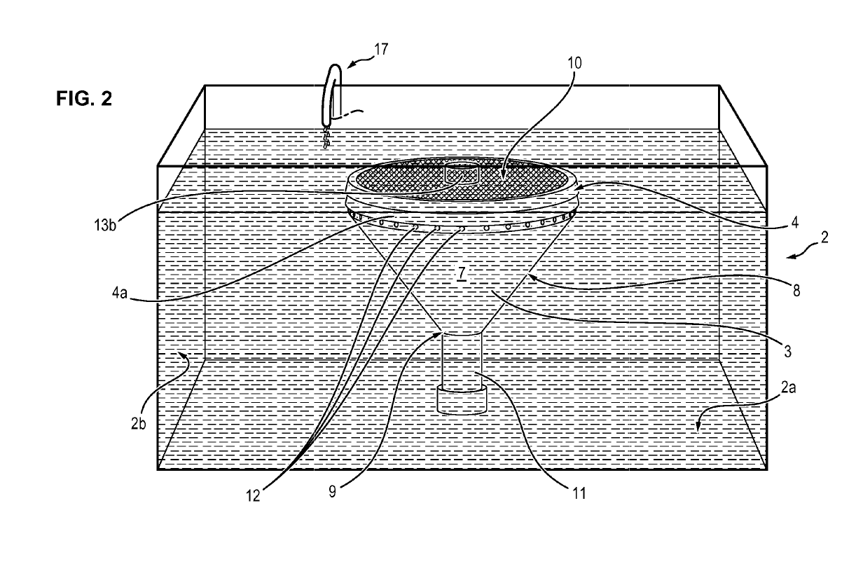

### DETAILED DESCRIPTION OF AN EMBODIMENT

A breeding system 1 for fish belonging to the Cyprinidae family, and more particularly for zebra fish of the species Danio rerio, will now be described in reference to the attached figures.

Such a breeding system 1 comprises:

a breeding tank 2 having a bottom 2a and side walls 2b,
a spawning support 3 placed in the breeding tank 2 and comprising a platform 4 forming a spawning area placed at a distance from the bottom 2a of the breeding tank 2, and
a water circulation system 17 configured to modify a water level in the breeding tank 2 and at least partially flood the platform 4 of the spawning support 3.

In nature, fish belonging to the Cyprinidae family, and more particularly the zebra fish of the species Danio rerio, breed during the rainy season. They are in fact stimulated by the rise in water which floods the riverbanks at a low water height. This concerns a behavioural reaction of these animals.

The breeding system 1 therefore allows to reproduce this phenomenon in a breeding tank 2 by keeping the males and the females together and by acting on the water level because of the water recirculation system and the spawning support 3 to obtain egg-laying on demand. In this way, the breeding system 1 decreases maintenance and especially the handling of animals, the work coming down to modifying the water level to allow or prohibit access to the platform 4 and authorise or stop spawning. The fish are stimulated mainly by access to the platform 4 which constitutes a spawning area and its low water height which simulates a flooded riverbank. The group effect in these gregarious fish has a stimulating effect on all the animals of the batch.

Furthermore, the breeding system 1 allows a better exploitation of the space available relative to classic systems of individual breeding. By keeping egg production equivalent to these classic systems, it provides better conditions for keeping animals and less breeding handling as well as less work time devoted to this activity, the simple modification of the water level in the breeding tank 2 producing fish spawning.

In an embodiment, the breeding tank 2 is bigger than tanks usually used for breeding these fish, which prevents the fish from hunting each other or trying to reproduce when the producing eggs is not preferred. The sexing and selection of breeding fish is also no longer necessary, because of the larger size of the tank.

For example, the breeding tank 2 can have a length of 510 mm for a width of 385 cm and a height of 320 mm, is to say a volume of around 60 L. The volume available for the fish is decisive in achieving a population density of around five adults per litre in the breeding tank 2. It is understood of course that a breeding tank 2 of larger volume can also be used.

The side walls 2b of the breeding tank 2 are preferably transparent to let an operator monitor the fish and the egg-laying.

In an embodiment, furthermore the system comprises a collecting tank 5 configured to harvest eggs laid by fish on the platform 4. This collecting tank 5 is therefore in communication with the platform 4 forming the spawning area to allow for harvesting of eggs.

For a breeding tank 2 of 60 L, the collecting tank 5 can for example have a length of 550 mm for a width of 300 mm and a height of 345 mm. It will be evident of course that a collecting tank 5 of larger volume can of course also be used.

A harvesting frame 15 of eggs can be placed in the collecting tank 5. The harvesting frame 15 can for example comprise a strainer having adapted meshing, typically 400 micrometers. This strainer 15 can be placed at the bottom 5a of the collecting tank 5, or by way of variant on a support so as to extend at a distance from said bottom 5a, for example perpendicularly to said bottom 5a.

Optionally, the harvesting frame 15 can be placed on a plinth placed on the bottom 5a of the collecting tank 5 to elevate the harvesting frame and/or the keep it perpendicular to the bottom 5a.

Optionally also, the harvesting frame 15, and if needed the plinth, can be fixed to a box 6 such as a maintenance box for the fish capable of letting water pass through without overflowing to prevent eggs from being swept into the collecting tank 5. The box 6 is in turn placed in the collecting tank 5, if needed under the outlet of the pipe 11 of the spawning support 3. In the example illustrated in FIG. 5, a strainer 15 is for example fixed on a flat support 15a which is inserted into a housing formed in the box.

In the following, the invention will be described more particularly in the event where the breeding system 1 comprises a collecting tank 5 in communication with the platform 4. But this is not limiting, the collecting tank 5 being optional.

The breeding tank 2 can be placed on the collecting tank 5 to reduce the bulk of the breeding system 1. Typically, the bottom 2a of the breeding tank 2 can be placed on the section of the walls of the collecting tank 5. As a variant, the collecting tank 5 and the breeding tank 2 can be stacked and monobloc. In this case, the breeding system 1 comprises a single tank, the bottom of which forms the bottom 5a of the collecting tank 5 and the side walls form the side walls 2b of the breeding tank 2 and of the collecting tank 5. This single tank also comprises an intermediate wall, extending at a distance from the bottom of the single tank, said intermediate wall forming the bottom 2a of the breeding tank 2.

Also, the same collecting tank 5 can be used for several breeding tanks 2 to further reduce their bulk and the equipment needed for breeding. The collecting tank 5 can have larger dimensions and serve both as and simultaneously for filtration, pumping and harvesting of eggs for several breeding tanks 2 in parallel. Optionally, the breeding tanks can be combined into a single water unit to allow optional breeding of several batches of animals. If needed, the breeding tank 2 can also have larger dimensions and be compartmented so as to create compartments equivalent to a single breeding tank 2, each compartment comprising a platform 4 to allow optional breeding of several batches of animals in parallel.

The spawning support 3 is configured to retrieve eggs laid by the fish on the platform 4 forming a spawning area and transfer them to the collecting tank 5. For this purpose, the spawning support 3 can especially comprise a funnel 7 in fluidic communication with the collecting tank 5, to which is fixed the platform 4 forming the spawning area.

In an embodiment, the funnel 7 comprises a truncated conical wall 8 having a lower orifice 9, an upper orifice 10 and a pipe 11. The lower orifice 9 is smaller than the upper orifice 10 and extends near the bottom 2a. The pipe 11 is also fixed in the region of a first end on the lower orifice 9 of the funnel 7 and in the region of a second end in the bottom 2a of the breeding tank 2. The pipe 11 passes through the bottom 2a of the breeding tank 2 so as to place the funnel 7 in fluidic communication with the collecting tank 5.

For example, in the event where the breeding tank 2 is placed on the collecting tank 5, the pipe 11 can quite simply terminate in the collecting tank 5.

In an embodiment, the conical wall 8 has a height of 150 mm, a diameter in the region of the upper orifice 10 of 300 mm and a diameter in the region of the lower orifice 9 of 33 mm. This embodiment can especially be implemented in a breeding tank of around 60 L.

As to the pipe 11, it can have a constant diameter equal to the diameter of the lower orifice 9. As a variant, to block a shutoff member 13 (see hereinbelow), the pipe 11 can have a diameter, in the region of the bottom 2a, smaller than the diameter of the lower orifice 9. For example, in the embodiment described hereinabove where the diameter of the pipe 11 in the region of the lower orifice 9 is equal to 33 mm, the diameter of the pipe 11 in the region of the bottom 2a can be equal to 22 mm.

The platform 4 is configured to form a spawning area of low water level in order to simulate a riverbank for the fish after a rise in water. This is why the platform 4 is placed at a distance from the bottom 2a of the breeding tank 2: in this way the platform 4 can be out of reach for the fish when the operators do not want to collect eggs, preventing the platform from being soiled (especially by fish faeces) prior to spawning, then be flooded so as to be at least partially immersed because of the water circulation system 17 to simulate the rise in water. During flooding, the tilting of the platform 4 has the zone of the surface exceeded up to 10 to 20%, creating a gentle slope under the surface available for the animals.

It is evident that the water circulation system 17 can operate continuously to allow filtration and circulation of the water in the breeding tank 2, which is necessary for the animals.

Furthermore, the platform 4 allows to harvest eggs without having to handle the fish, preventing the eggs from being mixed in with fish faeces.

For this, the platform 4 comprises a screen dimensioned so as to allow fish eggs only to enter the funnel 7. In other words, the meshing of the screen is selected larger than the size of fish eggs to let the eggs pass through, but smaller than the size of the fish to prevent them from entering the funnel 7. The screen allows to retrieve eggs laid by the fish simply and effectively, without risking perturbing the fish, which boosts their wellbeing and consequently the number of eggs laid.

The meshing of the screen can for example have meshes of 1 millimeter to 5 millimeters, for example of the order of 4 millimeters. The platform 4 is placed in a zone adjacent to the upper orifice 10 so as to extend at distance from the bottom 2a of the breeding tank 2. For example, the platform 4 can be placed on and fixed to the funnel 7 so as to cover its upper orifice 10. In this case, the screen of the platform 4 can for example be fixed to a joint 4a, typically made of plastic or silicone, which is sleeved onto the upper orifice 10 of the funnel 7.

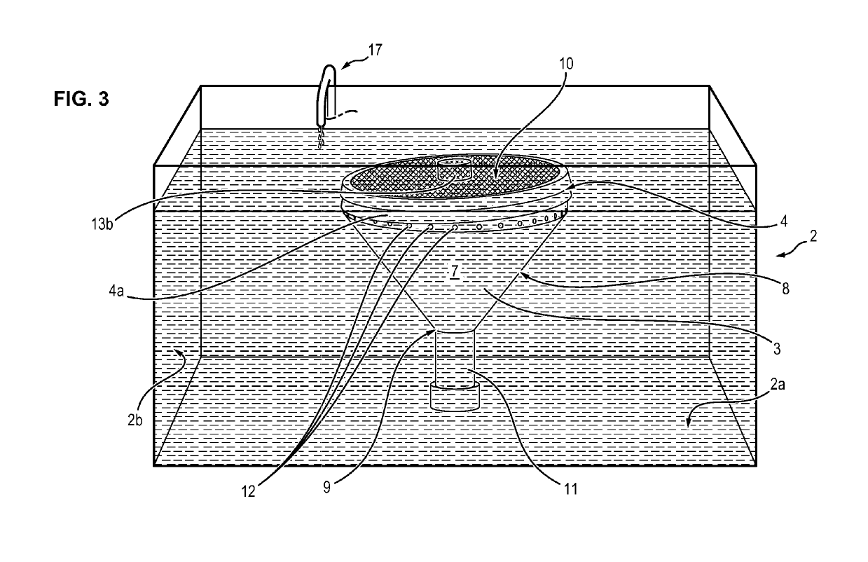

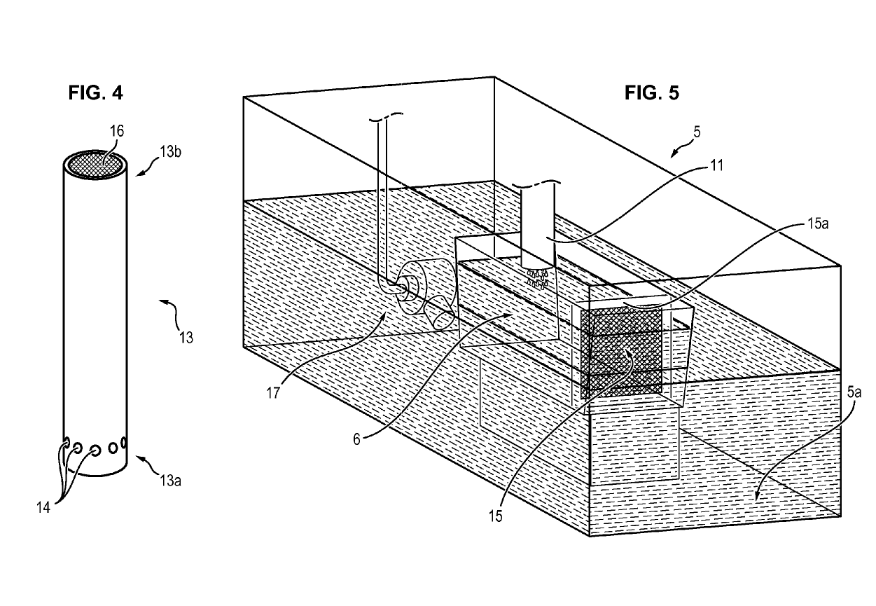

Optionally, the platform 4 can be tiltable to better simulate a riverbank for the fish. For example, the platform can be tilted by way of the joint 4a, which keeps said platform 4 in a tilted position on the segment of the upper orifice 10 as illustrated in FIG. 3.

A ratio between the surface of the platform 4 forming the spawning area and the surface of the bottom 2a of the breeding tank 2 is between 0.3 and 0.5.

Through perforations 12 can be formed in the conical wall 8 of the funnel 7, near the platform 4. As will be evident below, these perforations 12 passively, that is, without any action by an operator, allow to fix the water level in the breeding tank 2 when the breeding and egg-laying of the fish is not desired. The perforations 12 can for example be formed in the conical wall 8 at a distance between 1 cm and 5 cm from the platform 4. The diameter of the perforations lets water pass through but prevents adult breeding fish from passing through, currently 3 or 4 mm.

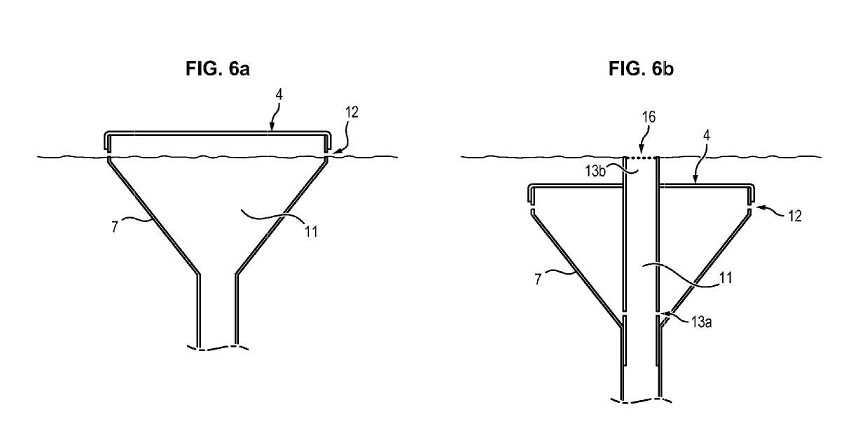

Furthermore, the breeding system 1 comprises a removable shutoff member 13 configured to at least partially block the pipe 11 of the spawning support 3 to increase the water level in the breeding tank 2 (see FIG. 6b). For this purpose, the shutoff member 13 can especially comprise a hollow pipe 13 having a first end 13a, configured to be inserted into the pipe 11 of the spawning support 3, and a second end 13b configured to project from the upper orifice 10 of the spawning support 3. The length of the hollow pipe 13 is therefore selected such that, when the hollow pipe 13 is introduced to the spawning support 3, its second end 13b extends above the platform 4. As will be evident below, the length of the hollow pipe 13 and consequently the height of its second end 13 relative to that of the platform 4, determine the water height in the breeding tank 2 when the platform 4 is flooded.

In the exemplary embodiment described hereinabove, wherein the lower orifice 9 has a diameter of 33 mm, the hollow pipe 13 can for example have a diameter of 32 mm. The length of the hollow pipe 13 can also be around 220 mm, when the height of the breeding tank 2 is 320 mm for a volume of 60 L.

Through-holes 14 are also formed near the first end 13a of the hollow pipe 13. The position of the holes 14 is selected such that when the hollow pipe 13 is introduced to the spawning support 3, said holes 14 extend near the lower orifice 9 of the funnel 7 to suction water (and eggs) into a lower zone of the funnel 7 while staying above the pipe 11 of the spawning support 3 so that the latter does not obstruct the holes 14.

Introducing the hollow pipe 13 in the pipe 11 of the spawning support 3 allows to block the pipe 11 of the spawning support 3 and therefore disallows discharge of water (and eggs) to the collecting tank 5 at first only via the holes 14 formed in the hollow pipe 13, then also via the orifice of the end 13b which determines the immersion water level (see FIG. 6b).

The size and number of holes 14 are selected so as to let eggs laid by the fish pass through, while sufficiently limiting the water rate to raise the water level in the breeding tank 2 above the platform 4. For example, the hollow pipe 13 can comprise between two and six holes each having a diameter between 3.5 mm and 6 mm, for example of the order of 4 mm (close to 10%), typically four equidistant holes of 4 mm each.

To allow introduction of the hollow pipe 13 to the spawning support 3, the platform 4 comprises a passage the dimensions of which are adjusted to the external diameter of the hollow pipe 13. If needed, a joint can be fixed on the contours of the passage to prevent fish from being able to enter the funnel 7 along the hollow pipe 13.

The passage is preferably formed in the extension of the pipe 11 of the spawning support 3 to make for easier insertion of the hollow pipe 13.

The water circulation system 17 can comprise piping 17, connecting the collecting tank 5 and the breeding tank 2, and a pump configured to suction water in the collecting tank 5 and bring up water in the breeding tank 2, via the piping.

If needed, the circulation system 17 can also comprise mechanical and biological filtration based on various adapted substrates, for example pozzolan, positioned upstream of the pump.

Use of the breeding system 1 for obtaining eggs on demand will now be described.

During a first step, the spawning support 3 is fixed in the breeding tank 2. For this purpose, the funnel 7 is fixed, via its pipe 11, in the bottom 2a of the breeding tank 2 such that the pipe 11 terminates in the collecting tank 5 located below.

The water circulation system 17 is also put in place. For example, piping can be placed so as to terminate both in the collecting tank 5 and also in the breeding tank 2. Furthermore, a pump can be fixed in the region of one of the pipes to allow circulation of water between the collecting tank 5 and the breeding tank 2 via the piping.

Finally, a strainer 15 is placed in the collecting tank 5, optionally on a support and/or in a box 6.

The collecting tank 5 and the breeding tank 2 are then filled with water. The water circulation system 17 is started. Due to perforations 12 formed in the conical wall 8 of the funnel 7, the water level in the breeding tank 2 arrives below the platform 4. The fish therefore have no access to the platform 4 as long as the operators have not decided to initiate spawning. Furthermore, the water level is stable, the volume of water exceeding the perforations 12 being discharged progressively via the perforations 12.

Water circulation between the breeding tank 2 and the collecting tank 5 can be continuous to provide continuous oxygen supply to the fish, to degas carbon dioxide and enable proper operation of filtration.

During a second step, once the biological stability of the medium is attained, male and female fish are placed in the breeding tank 2.

The breeding system 1 is then ready to be used to prompt egg-laying by the female fish (FIG. 6a).

It is clear that since the ratio between the surface of the platform 4 (screen) forming the spawning area and the surface of the bottom 2a of the breeding tank 2 is between 0.3 and 0.5, it is possible to leave male fish and female fish together in the breeding tank 2 outside spawning times. The steps of sexing, previous separation and combining of fish are therefore no longer necessary with this breeding system 1.

When spawning is planned, during a third step the water level in the breeding tank 2 is raised so as to flood the platform 4. If needed, the platform 4 can be tilted to simulate a riverbank.

For this purpose, the hollow pipe 13 can for example be introduced to the funnel 7 via the passage formed in the platform 4 to block the pipe 11 of the spawning support 3. The water level rises to reach its second end (FIG. 6b). When the water level reaches this second end, which is above the platform 4 to allow its flooding, the water surplus is discharged to the collecting tank 5, the water reaching the second end 13b of the hollow pipe, which is in fluidic communication with the interior of the pipe 11. It is therefore the length of the hollow pipe 13 and the height of its second end relative to the platform 4 which determines the water level in the breeding tank 2, when the latter is introduced into it.

If needed, a strainer 16 having a meshing the dimensions of which are similar to those of the screen can be fixed to the second end 13b of the hollow pipe 13 to prevent fish from being discharged with the water surplus into the collecting tank 5. The strainer 16 can for example comprise a mesh size of 3 mm.

Due to the water circulation system 17, it is possible to create a spawning area at low water height for the fish without having to introduce a new object visible to the fish in the breeding tank 2. Only the hollow pipe 13 is in fact introduced to the breeding tank 2: or this latter is not visible by the fish since it is placed in the funnel 7.

Typically, if the spawning support 3 had been introduced to or moved in the breeding tank 2 to flood the platform 4 when spawning is desired, the fish would have been perturbed by these movements and spawning would have been necessarily less effective.

The low water height on the platform 4 and the simulation of the rainy season resulting from the rise in the water level in the breeding tank 2 have the effect of stimulating the fish to breed. The females now lay eggs on the platform 4 which they identify as a riverbank. These eggs pass directly through the platform 4 and fall into the funnel 7, then are directed to the bottom of the funnel 7 then to the collecting tank 5, because of the holes 14 formed in the region of the first end of the blocking pipe 11 which allow low-rate evacuation of water and eggs. The eggs therefore have no time to stick to the walls of the funnel 7.

But the eggs accumulate on the strainer 15 of the collecting tank.

During a fourth step, when the fish have laid enough eggs, the strainer 15 can be taken out of the collecting tank 5 to collect eggs and the hollow pipe 13 can be taken out, freeing up the pipe 11 of the spawning support 3. The volume of water exceeding the perforations 12 formed in the funnel 7 is discharged in the collecting tank 5, especially via the perforations 12 formed in the conical wall 8.

The fish can then be left in the breeding tank 2 until the next spawning.

1. A breeding system for fish belonging to the Cyprinidae family, and more particularly for zebra fish of the species Danio rerio, said system comprising:
a breeding tank having a bottom and side walls,
a spawning support placed in the breeding tank and comprising a platform forming a spawning area placed at a distance from the bottom of the breeding tank, and
a water circulation system configured to modify a water level in the breeding tank and flood at least partially the platform of the spawning support,
wherein the spawning support comprises a funnel comprising a truncated conical wall having a lower orifice extending near the bottom of the breeding tank and in fluidic communication with the water circulation system by means of a pipe, and an upper orifice extending at a distance from the bottom, the platform being fixed near the upper orifice of the funnel, and the system comprises also a removable shutoff member configured to at least partially block the pipe of the spawning support so as to increase a water level in the breeding tank to at least partially flood the platform, the shutoff member comprising a pipe at the end of which through-holes are formed, said pipe having a height greater than a distance between the lower orifice and the upper orifice.

2. The breeding system according to claim 1, comprising also a collecting tank in communication with the platform, said collecting tank being configured to harvest eggs laid by fish on the platform.

3. The breeding system according to claim 1, wherein the collecting tank comprises a strainer configured to harvest eggs laid by fish on the platform.

4. The breeding system according to claim 2, said system comprising several breeding tanks in communication with a single collecting tank, said single collecting tank being in communication with the platform of each breeding tank and configured to harvest eggs laid by fish on said platforms.

5. The breeding system according to claim 2, said system comprising a compartmented breeding tank, each compartment comprising a platform in communication with the collecting tank, said collecting tank being configured to harvest eggs laid by fish on each of the platforms.

6. The breeding system according to claim 2, wherein the water circulation system comprises piping and a pump and is configured to circulate water between the breeding tank and the collecting tank so as to modify a water level in the breeding tank.

7. The breeding system according to claim 6, wherein the platform comprises a screen configured to prevent fish from entering the conical part of the spawning support while letting eggs enter the funnel.

8. The breeding system according to claim 6, wherein the conical wall of the funnel has through perforations formed at a predetermined distance from the platform forming a spawning area.

9. The breeding system according to claim 1, wherein the platform is tiltable.

10. The breeding system according to claim 1, wherein a ratio between the surface of the platform and a surface of the bottom of the breeding tank is between 0.3 and 0.5.

11. The breeding system according to claim 8, wherein the predetermined distance is between 1 cm and 5 cm.
